(19) United States
(12) Patent Application Publication
(10) Pub. No.: US 2019/0042574 A1
(43) Pub. Date: Feb. 7, 2019

(54) ELECTRONIC DEVICE AND METHOD FOR CONTROLLING THE ELECTRONIC DEVICE

(71) Applicant: SAMSUNG ELECTRONICS CO., LTD., Suwon-si (KR)

(72) Inventors: Wonsik KIM, Ansan-si (KR); Yoon-hee CHOI, Seoul (KR)

(73) Assignee: SAMSUNG ELECTRONICS CO., LTD., Suwon-si (KR)

(21) Appl. No.: 16/051,931

(22) Filed: Aug. 1, 2018

Related U.S. Application Data
(60) Provisional application No. 62/540,221, filed on Aug. 2, 2017.
(60) Provisional application No. 62/539,760, filed on Aug. 1, 2017.

(30) Foreign Application Priority Data
Jan. 19, 2018 (KR) 10-2018-0007301

(51) Int. Cl. G06F 17/30; G06K 9/32; G06F 3/0488; G06F 3/0484; G06N 3/08

(52) U.S. Cl. CPC G06F 17/30047; G06K 9/3241; G06F 17/30038; G06N 3/086; G06F 3/04842; G06F 3/04845; G06F 3/04883

(57) ABSTRACT

An artificial intelligence (AI) system utilizing a machine learning algorithm to receive an area in an image provide a first search result by using first text information describing an object in the area by using a trained model, and provide a second search result by using second text information describing an object in the second area using the trained model.

### CROSS-REFERENCE TO RELATED APPLICATIONS

This application claims the benefit under 35 U.S.C. § 119(e) of U.S. Provisional Application Nos. 62/539,760 and 62/540,221, filed on Aug. 1 and 2, 2017, respectively, in the U.S. Patent and Trademark Office, and priority under 35 U.S.C. § 119(a) from Korean Patent Application No. 10-2018-0007301, filed on Jan. 19, 2018, in the Korean Intellectual Property Office, and the disclosures of which are incorporated by reference herein in their entireties.

### BACKGROUND

### 1. Field

Apparatuses and methods consistent with example embodiments relate to an electronic device and a method for controlling the electronic device, and more particularly, to an electronic device that provides a search result with respect to a selected object, based on text information describing the selected object, and a method for controlling the same.

In addition, apparatuses and methods consistent with the disclosure relate to an artificial intelligence (AI) system for mimicking functions such as cognition, decision of human brain and the like, using a machine learning algorithm, and an application thereof.

### 2. Description of Related Art

Recently, artificial intelligence (AI) has been employed in various fields. AI is a system in which a machine learns, makes a decision, and becomes smart on its own to mimic the function of human intelligence, unlike the previous rule-based smart systems. As the AI system is developed, a recognition rate has improved and thus, for example, a taste of a user is more accurately understood. Accordingly, the previous rules-based smart system has been gradually replaced with a deep-learning AI system.

AI technology includes a machine learning (e.g., deep learning) and element technologies using machine learning.

Machine learning is an algorithm technology that classifies and learns features of input data by itself. Element technology is a technique that mimics functions such as cognition, decision of human brain and the like, using a machine learning algorithm such as deep learning and the like, and which may implement linguistic understanding, visual understanding, inference/prediction, knowledge expression, motion control and the like.

Linguistic understanding is a technique of recognizing a language and character of human speech and applying and processing the same, which includes natural language processing, machine translation, a conversation system, question and answer, voice recognition and synthesis, and the like. Visual understanding is a technique of recognizing and processing an object akin to human sight, which includes object recognition, object tracking, image search, human recognition, scene understanding, space understanding, image improvement, and the like. Inference prediction is a technique of determining information and making a logical inference and prediction, which includes knowledge/probability-based inference, optimization prediction, preference-based plan, recommendation and the like. Knowledge expression is a technique of performing automation processing with respect to experience information of human with knowledge data, which includes knowledge construction (data generation/classification), knowledge management (data usage) and the like. Motion control is a technique of controlling an autonomous driving of a vehicle and movement of a robot, which includes a motion control (navigation, collision, drive), manipulation control (behavioral control), and the like.

In recent years, to search for information relating to an image, the user may directly input a search word for the image in a search window to search for information relating to the image or search for information relating to the image by using meta information of the image.

In a case in which the user directly inputs a search word to search for information relating to an image, it is necessary that the user precisely inputs the search word, which is inconvenient. Further, in a case in which the user searches for information relating to the image by using meta information of the image, there may be a problem that a search result undesired by the user is returned.

### SUMMARY

One or more example embodiments provide an electronic device capable of obtaining text information describing an object selected by a user by using a trained model to obtain a specific search result with respect to the selected object, and a method for controlling the same.

According to an aspect of an example embodiment, there is provided an electronic device, comprising: a display; a communication interface; a processor configured to control the display and the communication interface; and a memory configured to store at least one program executed by the processor. The processor may be configured to control the display to display an image, to receive a user input indicating an area of the display, if the area of the display indicates a first area of the display at which a first object in the image is displayed, obtain a first search result by using first text information describing the first object by using a trained model, and if the area of the display indicates is a second area of the display at which a second object in the image is displayed, obtain a second search result by using second text information describing the second object by using the trained model.

According to an aspect of an example embodiment, there is provided a computer-readable recording medium for storing a program that implements a method of an electronic device providing a search result. The method comprises: displaying an image on the electronic device; receiving a user input that indicates area displayed on the electronic device; if the area of the display indicates is a first area of the display at which a first object in the image is displayed, obtaining a first search result by using first text information describing the first object using a trained model; and if the area of the display indicates is a second area of the display at which a second object in the image is displayed, obtaining a second search result using second text information describing the second object by using the trained model.

According to the various example embodiments described above, the user can obtain a detailed search result with respect to an object selected by the user from among objects included in an image more quickly and conveniently

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects of certain embodiments of the disclosure will be more apparent from the following description taken in conjunction with the accompanying drawings, in which:

FIG. 1 is a diagram illustrating an electronic device for obtaining text information with respect to an object selected by a user and providing a search result with respect to an image, according to an example embodiment;

FIG. 2A is a block diagram illustrating an electronic device, according to an example embodiment;

FIG. 2B is a block diagram illustrating an electronic device, according to an example embodiment;

FIG. 3 is a block diagram illustrating obtaining text information with respect to an object selected by a user and a trained model, according to an example embodiment;

FIG. 4 is a flowchart illustrating a method of providing a search result, according to an example embodiment;

FIG. 5 is a flowchart illustrating a method of providing a search result, according to an example embodiment;

FIG. 6 is a diagram illustrating obtaining text information of an object according to a search category, according to an example embodiment;

FIG. 7 is a diagram illustrating obtaining text information of an object according to a type of the object, according to an example embodiment;

FIG. 8 is a diagram illustrating modifying an item description, according to an example embodiment;

FIGS. 9 and 10 are diagrams illustrating modifying an item description, according to an example embodiment;

FIG. 11 is a diagram illustrating searching for information relating to an image using a UI, according to an example embodiment;

FIG. 12 is a flowchart illustrating a method of controlling an electronic device, according to an example embodiment;

FIG. 13 is a block diagram of an electronic device, according to an example embodiment;

FIGS. 14A and 14B are block diagrams of an electronic device, according to an example embodiment;

FIGS. 15 and 16 are flowcharts of a trained model, according to an example embodiment;

FIG. 17 is a flowchart illustrating a method for controlling an electronic device for providing a search result, according to an example embodiment; and

FIG. 18 is a flowchart illustrating providing a search result, according to an example embodiment.

The same reference numerals are used to represent the same elements throughout the drawings.

### DETAILED DESCRIPTION

Example embodiments of the disclosure are described in detail with reference to the accompanying drawings. However, it should be understood that the disclosure is not limited to the specific embodiments described hereinafter, but includes various modifications, equivalents, and/or alternatives of the embodiments of the disclosure. In relation to explanation of the drawings, similar drawing reference numerals may be used for similar constituent elements.

In the description, the term “has,” “may have,” “includes” or “may include” indicates existence of a corresponding feature (e.g., a numerical value, a function, an operation, or a constituent element such as a component), but does not exclude existence of an additional feature.

In the description, the term “A or B,” “at least one of A or/and B,” or “one or more of A or/and B” may include all possible combinations of the items that are enumerated together. For example, the term “A or B” or “at least one of A or/and B” may designate (1) at least one A, (2) at least one B, or (3) both at least one A and at least one B.

The expression “1,” “2,” “first,” or “second” as used herein may modify a variety of elements, irrespective of order and/or importance thereof, and only to distinguish one element from another. Accordingly, without limiting the corresponding elements.

If it is described that a certain element (e.g., first element) is “operatively or communicatively coupled with/to” or is “connected to” another element (e.g., second element), it should be understood that the certain element may be connected to the other element directly or through still another element (e.g., third element). Meanwhile, when one element (e.g., first element) is “directly coupled” with or “directly connected to” another element (e.g., second element), it may be understood that there is no element (e.g., third element) present between the element and the other element.

In the description, the term “configured to” may be changed to, for example, “suitable for,” “having the capacity to,” “designed to,” “adapted to,” “made to,” or “capable of” under certain circumstances. The term “configured to (set to)” does not necessarily mean “specifically designed to” in a hardware level. Under certain circumstances, the term “device configured to” may refer to “device capable of” doing something together with another device or components. For example, the phrase “processor configured to perform A, B, and C” may denote or refer to a dedicated processor (e.g., embedded processor) for performing the corresponding operations or a generic-purpose processor (e.g., CPU or application processor) that can perform the corresponding operations through execution of one or more software programs stored in a memory device.

Electronic devices in accordance with various embodiments of the disclosure may include at least one of, for example, smart phones, tablet PCs, mobile phones, videophones, electronic book readers, desktop PCs, laptop PCs, netbook computers, workstations, a portable multimedia player (PMP), an MP3 player, a medical device, a camera, and a wearable device. A wearable device may include at least one of an accessory type (e.g.: watch, ring, bracelet, ankle bracelet, necklace, glasses, contact lens, or head-mounted-device (HMD)), fabric or cloth-embedded type (e.g.: e-cloth), body-attached type (e.g.: skin pad or tattoo), or bioimplant circuit. In some example embodiments, an electronic apparatus may include, for example, at least one of television, digital video disk (DVD) player, audio, refrigerator, air-conditioner, cleaner, oven, microwave, washing machine, air cleaner, set top box, home automation control panel, security control panel, media box (ex: Samsung HomeSyncM, Apple TV™, or Google TV™), game console (ex: Xbox™, PlayStation™), e-dictionary, e-key, camcorder, or e-frame.

In another example embodiment, an electronic apparatus may include various medical devices (ex: various portable medical measuring devices (blood glucose monitor, heart rate monitor, blood pressure measuring device, or body temperature measuring device, etc.), magnetic resonance angiography (MRA), magnetic resonance imaging (MRI), computed tomography (CT), photographing device, or ultrasonic device, etc.), navigator, global navigation satellite system (GNSS), event data recorder (EDR), flight data recorder (FDR), vehicle info-tainment device, e-device for ships (ex: navigation device for ship, gyrocompass, etc.), avionics, security device, head unit for vehicles, industrial or home-use robots, drone, ATM of financial institutions, point of sales (POS) of shops, or internet of things device (ex: bulb, sensors, sprinkler, fire alarm, temperature controller, streetlight, toaster, sporting goods, hot water tank, heater, boiler, etc.).

Also, the term “user” may refer to a person who uses an electronic apparatus or an apparatus (e.g., an artificial intelligence (AI) electronic apparatus) that uses the electronic apparatus.

One or more example embodiments will be described in detail with reference to the accompanying drawings.

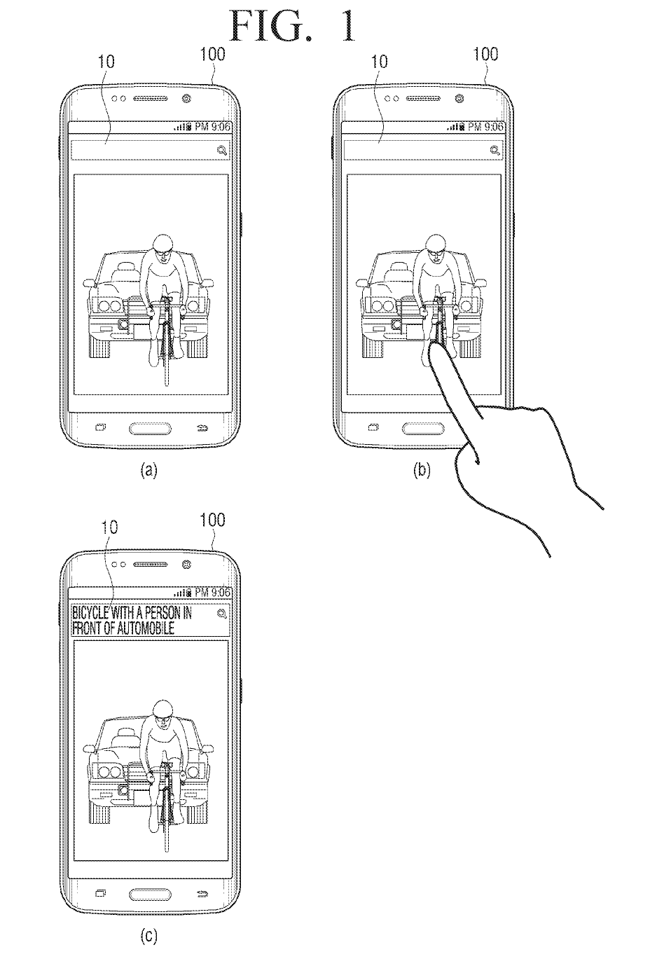

FIG. 1 is a diagram illustrating an electronic device for obtaining text information with respect to an object selected by a user and providing a search result with respect to an image, according to an example embodiment. An electronic device 100 may display an image (e.g., a photo), as illustrated in section (a) of FIG. 1. In this regard, the image may include a plurality of objects (e.g., a bicycle, an automobile, a person riding a bicycle, and the like).

Next, the electronic device 100 may detect a user input to select an area (or an object) including an object (e.g., a bicycle), as illustrated in section (b) of FIG. 1. For example, the electronic device 100 may detect a long press touch which touches one point of an object for a preset time. In addition, the electronic device 100 may detect a user input to multi-touch an object, touch an object according to a particular amount of pressure applied to the display screen, draw a line around an object or draw a diagonal line to pass through at least portion of an object by means of a finger, an electronic pen, and the like. In addition, the electronic device 100 may detect a user input to touch an object after (or while) pressing a button (e.g., a button to execute an artificial intelligence function) provided in the electronic device 100. In addition, the electronic device 100 may detect a user input to select an object using a predefined action.

Next, the electronic device 100 may obtain text information to describe an object selected in an image by means of a trained model. In detail, by using a first model (e.g., a convolutional neural network (CNN) model and the like) trained to receive one or more images as input and obtain information relating to the one or more objects and/or a plurality of objects included in the image, the electronic device 100 may obtain information relating to the one or more objects and/or the plurality of objects included in the image. For example, the electronic device 100 may obtain information relating to an object, such as “bicycle,” “automobile,” “person,” “road,” and the like, from the image illustrated in section (a) of FIG. 1 according to the user input by using the first model. In addition, the electronic device 100 may input information relating to a plurality of objects and information (e.g., a coordinate value and the like) relating to an area selected by a user and obtain text information for describing an object included in the selected area from among the objects in the image by means of a second model (e.g., a recurrent neural network (RNN) and the like) trained to obtain text information for the objects included in the selected area from among the plurality of objects. In this regard, the text information for the objects included in the selected area may include at least one of information relating to a relationship between an object included in the selected area and another object, detailed description information for an object included in the selected area, and behavior information for an object included in the selected area. For example, the electronic device 100 may obtain “a bicycle with a person in front of an automobile” as text information for an object included in the selected area of section (b) of FIG. 1 by means of the second model.

Accordingly, in a case in which a bicycle object is selected from among objects included in an image, the electronic device 100 may recognize an object “bicycle.” But, in the disclosure, the information “bicycle with a person in front of an automobile” indicating a relationship between the selected object and another object may be obtained through the trained first model and the trained second model.

In particular, when an area is selected by a user, the electronic device 100 may obtain first text information to describe an object within the area acquired from the image by using a trained model (i.e., the first model and the second model). In addition, when an area is selected by a user, the electronic device 100 may obtain second text information to indicate an object within the area acquired from the image by using a trained model. In other words, the electronic device 100 may obtain information relating to an object included in the selected area according to an area selected by the user.

In addition, the electronic device 100 may obtain tag information of an image that includes information relating to the image. In addition, the electronic device 100 may input information relating to a plurality of objects, information relating to an area selected by a user and tag information and obtain text information for describing an object included in the selected area. For example, the electronic device 100 may obtain tag information of an image, and may obtain time information and location information at which the image is captured, and generate text information “bicycle ridden in xxx on dd/mm/yyyy” based on the obtained time information.

In addition, the electronic device 100 may obtain text information based on a search category set according to a user input. For example, in a case in which a search category is a news category, the electronic device 100 may obtain text information “bicycle with a person in front of an automobile” to provide factual information for an object included in the selected area. In a case in which the search category is a shopping category, the electronic device 100 may obtain text information “brown cycle” to provide shopping information for an object included in the selected area.

In a case in which text information is obtained, the electronic device 100 may input the obtained text information in a search window, as illustrated in section (c) of FIG. 1. According to an example embodiment, when a user input for a search request is received, the electronic device 100 may generate a query for search based on the obtained text information. In addition, the electronic device 100 may transmit the generated query to an external search server and receive a search result, and provide the received search result. According to another example embodiment, when a user input for a search request is received, the electronic device 100 may search for an image associated with an object selected from among pre-stored images based on the obtained text information. In addition, the electronic device 100 may provide the search result.

According to various example embodiments, the electronic device 100 may use an image and information relating to a point at which a user input with respect to the image displayed on a screen of the electronic device 100 is detected in a recognition model as an input data and obtain information relating to an object. In detail, the electronic device 100 may recognize an object, by inputting an image and information relating to a point at which a user input is detected to an object recognition model trained to recognize the object. In the disclosure, the trained first model or the trained second model may be constructed in consideration of an applicable field of a recognition model, a computer performance of a device, or the like. For example, the first model may be trained to receive an image and/or an object therein as input and estimate information relating to an object included in the image. The second model may be trained to receive information relating to a plurality of objects and information relating to the selected area as input and obtain text information for an object included in the selected area from among the plurality of objects. The trained model may be, for example, a model based on a neural network. The recognition model may be designed to simulate a human brain structure on the computer, and include a plurality of network nodes having weight values and simulating neurons of a human neural network. Each of the plurality of network nodes may form a connection relationship so that neurons simulate their synaptic activity exchanging signals through synapse. In this regard, the first model may be implemented as a CNN model, and the second model may be implemented as an RNN model. However, this is only exemplary, and the first and second models may be implemented as other models. In the disclosure, the first model and the second model are constructed separately. However, this is only an example, and the first model and the second model may not be constructed separately and a CNN model and an RNN model may be combined with each other and implemented as a single trained model.

In addition, the electronic device 100 may use an artificial intelligence agent to search for information relating to an objected selected by the user as described above. In this regard, the artificial intelligence agent may be a program exclusive for providing an artificial intelligence (AI)-based service (e.g., voice recognition service, secretary service, translation service, search service, and the like), and may be executed by the existing universal processor (e.g., CPU) or an additional AI-exclusive processor (e.g., GPU). In particular, the artificial intelligence agent may control various modules.

In detail, in a case in which an object on an image is selected by a preset user input (e.g., long-press and the like) or an area in which an object is included is selected after a button (e.g., a button for executing an artificial intelligence agent) provided in the electronic device 100 is activated, the artificial intelligence agent may be operated. In addition, the artificial intelligence agent may obtain text information for an object included in an area selected through a user input, and obtain an image related to the selected object based on the text information.

The artificial intelligence agent may also be operated when a particular icon on the screen is touched or a button (e.g., a button for executing an artificial intelligence agent) provided in the electronic device 100 is activated. Alternatively, the artificial intelligence agent may be in a pre-executed state before a preset user input, with respect to an area in which an object is included, is detected or before a button provided in the electronic device 100 is selected. In this regard, after a preset user input, with respect to an area in which an object is included, is detected or after a button provided in the electronic device 100 is selected, the artificial intelligence agent of the electronic device 100 may perform a search function for the selected object and return information related to the selected object as a result of the search function. In addition, the artificial intelligence agent may be in a standby state before a preset user input with respect to an object is detected or before a button provided in the electronic device 100 is selected. In this regard, the standby state may be a state in which the reception of a predefined user input to control the initiation of an operation of the artificial intelligence agent is detected. While the artificial intelligence agent is in a standby state, when a preset user input for an object is detected or a button provided in the electronic device 100 is selected, the electronic device 100 may operate the artificial intelligence agent, and search for related information for the selected object and provide the found information.

Meanwhile, the artificial intelligence agent may control various modules.

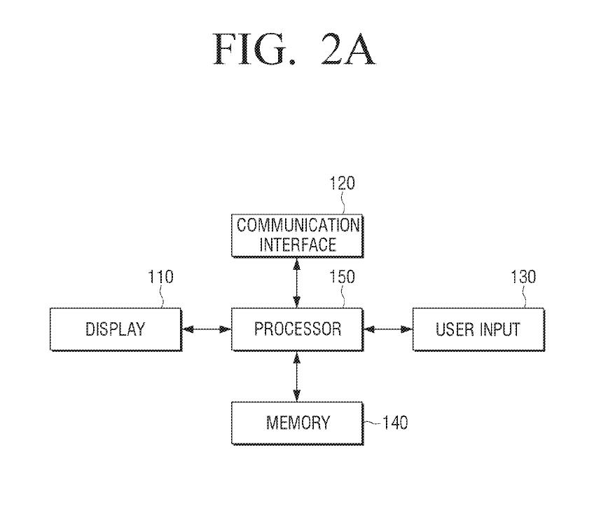

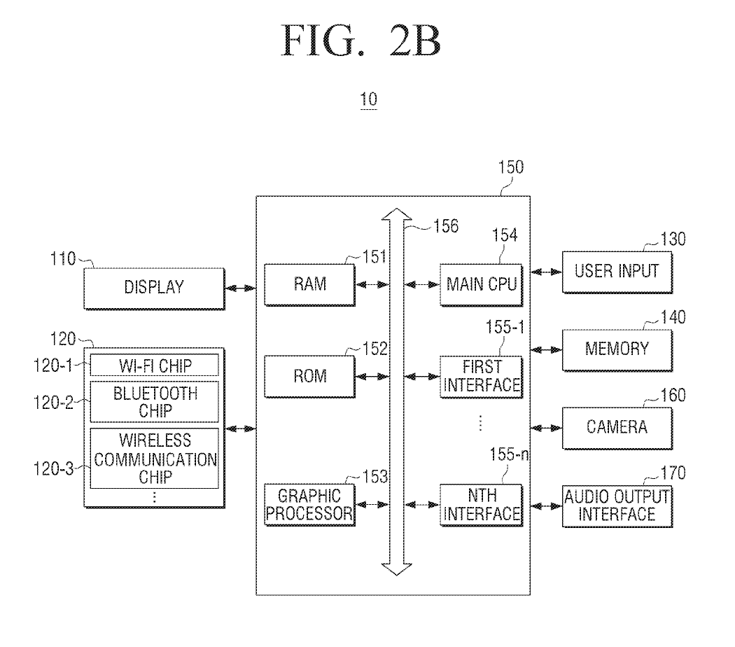

FIGS. 2A and 2B are block diagrams illustrating an electronic device, according to an example embodiment.

As illustrated in FIG. 2A, the electronic device 100 may include a display 110, a communication interface 120, a user input 30, a memory 140, and a processor 150. The elements illustrated in FIG. 2A may implement the example embodiments of the disclosure, and appropriate hardware/software elements apparent to those skilled in the art may be further included in the electronic device 100.

The display 110 may display various screens thereon. In particular, the display 110 may display an image that includes a plurality of objects. In addition, the display 110 may receive user input of a search window for performing a search using obtained text information and various user interfaces (UIs) for modifying the text information. In addition, the display 110 may display a search result.

The communication interface 120 may communicate with external devices in various communication methods. For example, the communication interface 120 may perform communication with an external search server and receive a search result in response to a query generated based on text information. In addition, in a case in which a trained model is stored in an additional artificial intelligence server, the communication interface 120 may perform communication with the artificial intelligence server and receive text information for an object included in a selected area.

The user input 130 may receive a variety of user inputs and transfer the received user inputs to the processor 150. In particular, the user input 130 may include a touch sensor, a (digital) pen sensor, a pressure sensor, a key, or a microphone. The touch sensor may, for example, use at least one among a capacitive method, a resistive method, an infrared method, and an ultrasonic method, and may coordinate with the display 110 or may be integrated with the display 110 to obtain the user input. The (digital) pen sensor may, for example, be part of a touch panel or include an additional sheet for recognizing use, and may coordinate with the display 110 or may be integrated with the display 110 to obtain the user input. The key may, for example, include a physical button, an optical key, or keypad. The microphone may be a configuration for receiving a user voice, which may be provided inside the electronic device 100. However, this is only an example, and the microphone may be provided outside the electronic device 100 and electrically connected to the electronic device 100.

For example, the user input 130 may obtain an input signal according to a preset user touch to select an object or a user input to select a button provided outside the electronic device 100. In addition, the user input 130 may transmit the input signal to the processor 150.

The memory 140 may store a command or data regarding at least one of the other elements of the electronic device 100. The memory 140 may be implemented as a non-volatile memory, a volatile memory, a flash memory, a hard disk drive (HDD) or a solid state drive (SDD). The memory 140 is accessed by the processor 150 and the reading/recording/modification/deletion/update of data by the processor 150 can be performed. According to an example embodiment of the disclosure, the memory may include the memory 140, read-only memory (ROM) and random access memory (RAM) within the processor 150, and a memory card attached to the electronic device 100 (e.g., micro secure digital (SD) card or memory stick). Also, the memory 140 may store a program, data, and the like for constituting various types of screens that will be displayed in the display area of the display 110.

For example, the memory 140 may store a program for carrying out an artificial intelligence agent. In this regard, the artificial intelligence agent may be a personalized program for providing various services for the electronic device 100.

In addition, the memory 140 may store a first model and a second model to obtain text information describing an object selected in an image.

The processor 150 may be electrically connected to the display 110, the communication interface 120, the user input 130, and the memory 140, and control the overall operations and functions of the electronic device 100. For example, the processor 150 may obtain text information for an object selected in an image by using a trained artificial intelligence model, and perform a search operation based on the obtained text information, when executing instructions, programs, and/or data stored in the memory 140.

In detail, the processor 150 may control the display 110 to provide an image including a plurality of objects. When a user input to select one of the plurality of objects is received through the user input 130, text information to describe an object included in a selected area in an image may be obtained using the trained model. In addition, the processor 150 may generate a query based on the obtained text information, and control the communication interface 120 to transmit the generated query to an external search server. In addition, the processor 150 may receive a search result in response to a query from the external search server via the communication interface 120, and control the display 110 to provide the received search result.

FIG. 2B is a block diagram illustrating an electronic device 100, according to an example embodiment.

As illustrated in FIG. 2B, the electronic device 100 may include a display 110, a communication interface 120, a user input 130, a memory 140, a processor 150, a camera 160, and an audio output interface 170. Since the display 110, the memory 140, and the user input 130 are described in FIG. 2A, the duplicate explanation thereof will be omitted.

The communication interface 120 may communicate with various types of external devices according to various manners of communication. The communication interface 120 may include at least one among a Wi-Fi chip 120-1, a Bluetooth chip 120-2, and a wireless communication chip 120-3. The processor 150 may perform communication with an external chatting server or various types of external devices by using the communication interface 120. In addition, the communication interface 120 may communicate with an external device through various communication chips, such as NFC communication module and the like.

The camera 160 may capture an image including at least one object. In this regard, the camera 160 may be provided on at least one of a front side and rear side of the electronic device 100. Meanwhile, the camera 160 may be provided inside the electronic device 100. However, this is only an example, and the camera 160 may be present outside the electronic device 100 and connected to the electronic device 100 wirelessly or via a wired cable.

The audio output interface 170 may include various audio output circuitry and is configured to output various kinds of alarm sounds or voice messages in addition to various audio data on which various processing operations such as decoding, amplification, and noise filtering are performed by an audio processor (not illustrated). Specifically, the audio output interface 170 may be implemented to be speaker; this is merely one of various example embodiments of the disclosure. The audio output interface 170 may be implemented to be output component that can output the audio data.

The processor 150 (or the controller) may control an overall operation of the electronic device 100 by using various types of programs stored in the memory 140.

The processor 150 may include the RAM 151, the ROM 152, a graphic processor 153 (GPU), a main central processing unit (CPU) 154, first through nth interfaces 155-1 through 155-n, and a bus 156. The RAM 151, the ROM 152, the graphic processor 153, the main CPU 154, and the first to the nth interface 155-1-155-n may be interconnected through the bus 156.

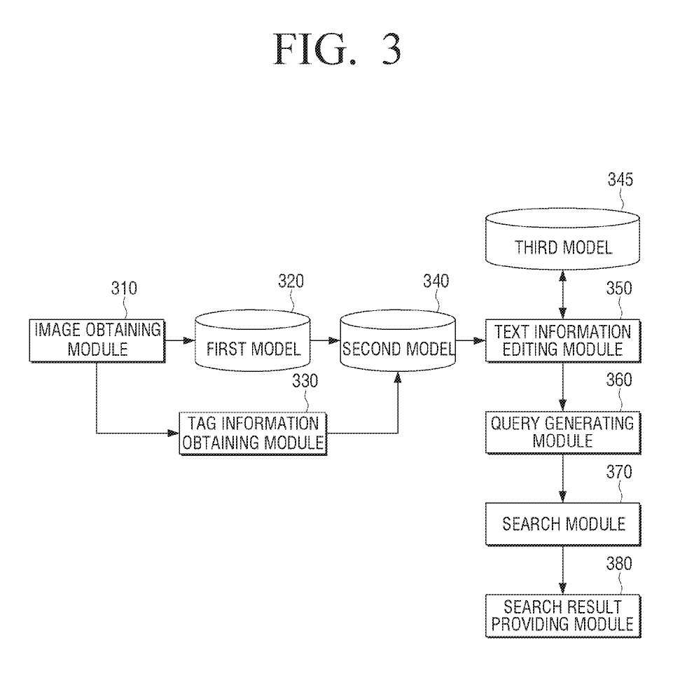

FIG. 3 is a block diagram illustrating obtaining text information with respect to an object selected by a user and a trained model, according to an example embodiment.

As illustrated in FIG. 3, the electronic device 100 may include an image obtaining module 310, a first model 320, a tag information obtaining module 330, a second model 340, a third model 345, a text information editing module 350, a query generating module 360, a search module 370, and a search result providing module 380.

The image obtaining module 310 may obtain an image that includes a plurality of objects. In detail, the image obtaining module 310 may obtain an image via the camera 160, and obtain an image from an external device or an external server via the communication interface 120.

The first model 320 may be an artificial intelligence model trained to obtain (or estimate) information relating to an object included in an image by using the image as an input data. For example, the first model 320 may obtain information relating to a plurality of objects included in the image by using the image as an input data. In this regard, the first model 320 may be a convolution neural network (CNN) model, but this is only an example. The first model 320 may be implemented as another model capable of recognizing an object included in the image.

The tag information obtaining module 330 may obtain tag information included in an image data. For example, the tag information obtaining module 330 may obtain various tag information including detailed image information (e.g., image size, file format, compression form and the like), image capture date, image capture location, person capturing the image, image capture device, information relating to an object included in the image, etc.

The second model 340 may be a model trained to obtain text information for an object included in an area selected by a user from among a plurality of objects by using information relating to the plurality of objects and information relating to the area selected by the user as input data. In particular, text information for an object included in an area selected by a user may be obtained using information relating to the plurality of objects obtained from the first model 320, the information relating to the area selected by the user, and the tag information obtained from the tag information obtaining module 330 as input data of the second model 340. In this regard, the second model 340 may be implemented as a recurrent neural network (RNN) model capable of processing a plurality of pieces of information as text information including a plurality of words. However, this is only an example, and the second model 340 may be implemented as a different model capable of processing a plurality of pieces of information as text information including a plurality of words.

In particular, the second model 340 may, according to an area selected by a user, obtain text information of an object included in the selected area. For example, in a case in which the area selected by the user is a first area, the second model 340 may obtain text information of a first object included in the first area. In a case in which the area selected by the user is a second area, the second model 340 may obtain text information of a second object included in the second area.

In this regard, the second model 340 may be trained so that information relating to different description items is obtained according to a type of object. In addition, the second model 340 may be trained so that different text information is obtained according to a search category.

The text information editing module 350 may be a module for editing text information obtained from the second model 340. In particular, the text information editing module 350 may provide a UI for changing a word or description included in at least one of a plurality of items included in text information. In addition, the text information editing module 350 may provide a UI for setting a weight value for a word included in at least one of a plurality of description items included in the text information.

In addition, the text information editing module 350 may generate an image and a new image corresponding to the edited text information by using a third model 345. In this regard, the third model 345 may be a model trained to generate a new image by using the image and the edited text information as input data, and may be implemented as a generative adversarial network (GAN).

The query generating module 360 may generate a query including text information edited from the text information editing module 350 and a new image generated from the third model 345.

The search module 370 may search for information related to a selected object or related images based on the generated query. In an example embodiment, the search module 370 may transmit the generated query to an external search server, and receive a search result in response to the query from the external search server and search for information relating to the selected object or related images. In another example embodiment, the search module 370 may compare tag information (or text information) included in a pre-stored image with text information included in the query and search for images stored in the electronic device 100.

The search result providing module 380 may provide a user with a search result returned by the search module 370 (i.e., information relating to the selected object or related images). In this regard, the search result providing module 380 may provide the search result on in a search result window on a display of the electronic device, but this is only an example. The search result providing module 380 may provide the search result in any area of the screen.

In the example embodiment described above, it is described that the first to third models are stored in the electronic device 100. However, this is only an example, and the first to third models may be stored in an external server. In this case, the electronic device 100 may perform the operation described above, through communication with an external server.

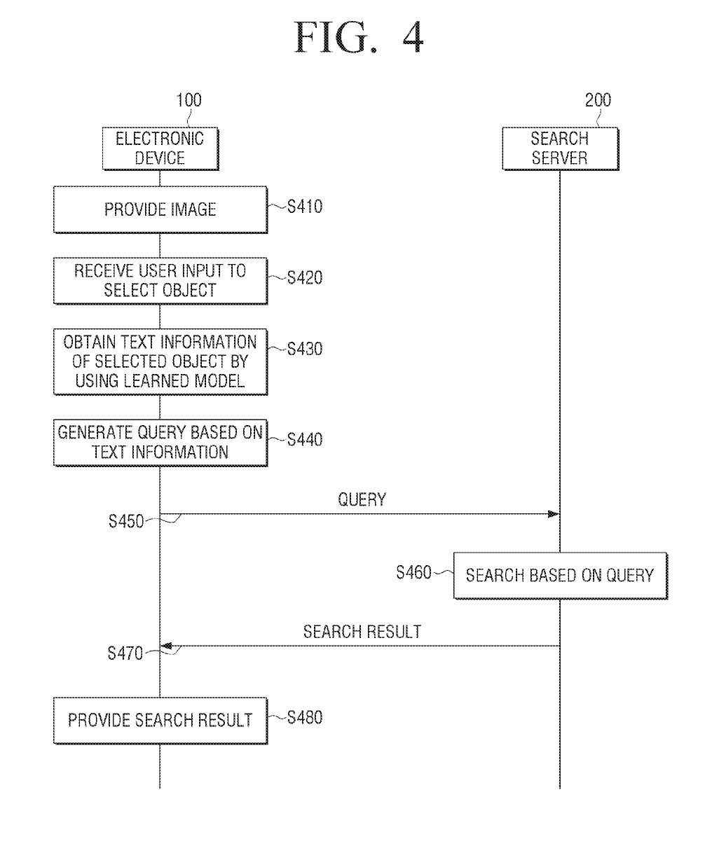

FIG. 4 is a flowchart illustrating a method of providing a search result, according to an example embodiment.

First, the electronic device 100 may display an image thereon, at operation S410. The image may include a plurality of objects.

The electronic device 100 may receive a user input to select an object, at operation S420. The user input may be implemented as a variety of touch inputs, such as a long press touch input to touch one point of an area in which an object is included for a predetermined time, a multi touch input to multi-touch an object with a finger, an electronic pen, and the like, a force touch input to touch with a force, and a drawing touch input to draw in a peripheral area of an object, and may be implemented as, after (or while) a button provided in the electronic device 100 (e.g., a button to execute an artificial intelligence function) is pressed, a user input to touch an object.

The electronic device 100 may obtain text information of the selected object by using a trained model, at operation S430. In detail, the electronic device 100 may input an image to the first model 320 and obtain information relating to a plurality of objects included in the image. In addition, the electronic device 100 may obtain text information for the selected object by inputting information relating to the plurality of objects and information relating to a selected area. In addition, the electronic device 100 may obtain text information with respect to the selected object by inputting tag information of an image in addition to the information relating to the plurality of objects and information relating to the selected area obtained through the first model 320. The second model 340 may obtain different text information according to a search category.

The electronic device 100 may generate a query for search based on the obtained text information, at operation S440. In particular, the electronic device 100 may edit the obtained text information according to a user command and generate a query. In detail, the electronic device 100 may change a word for at least one of a plurality of description items included in the obtained text information to another word or set a weight value.

The electronic apparatus 100 may transmit the obtained query to the search server 200, at operation S450.

The search server 200 may perform a search based on the query, at operation S460. In detail, the search server 200 may search for information or image related to the selected object based on text information included in the query. Alternatively, the search server 200 may perform a search according to a search category set by a user. For example, in a case in which a user sets a news category, the search server 200 may search for a news content included in the news category in response to the query.

The search server 200 may return a search result to the electronic device 100, at operation S470, and the electronic device 100 may provide the search result, at operation S480. In this regard, the electronic device 100 may provide the search result separately from an image or together with the image.

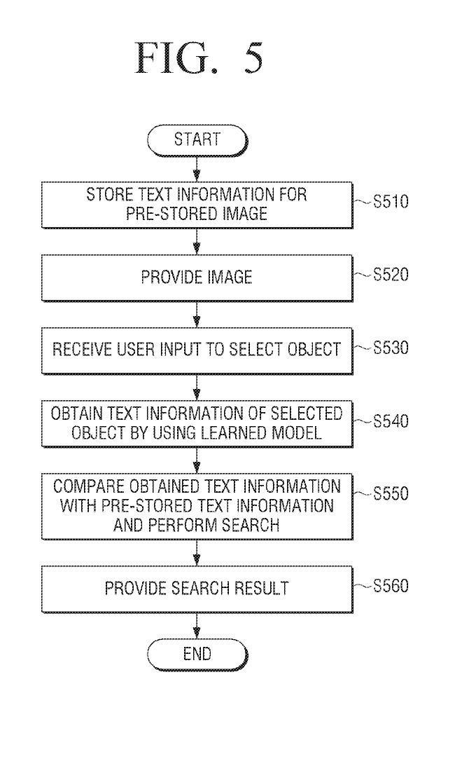

FIG. 5 is a flowchart illustrating a method of providing a search result, according to an example embodiment.

In operation S510, the electronic device 100 may store text information for a pre-stored image. In detail, the electronic device 100 may provide input to the first model 320 and the second model 340 and obtain text information for an object included in the image. The electronic device 100 may obtain text information for each of a plurality of objects. In addition, the electronic device 100 may match the image with text information for each of the plurality of objects and store the matching text information in association with the objects.

The electronic device 100 may provide an image, at operation S520. That is, the electronic device 100 may provide one of pre-stored images or an image received from an external device. In this regard, a plurality of objects may be included in an image provided.

The electronic device 100 may receive a user input to select an object, at operation S530. The user input may be implemented as a variety of touch inputs, such as a long press touch input, a multi touch input, a force touch input, and a drawing touch input, and may be implemented as, after (or while) a button provided in the electronic device 100 (e.g., a button to execute an artificial intelligence function) is pressed, a user input to touch an object.

The electronic device 100 may obtain text information of the selected object by using a trained model, at operation S540. In detail, the electronic device 100 may input an image to the first model 320 and obtain information relating to a plurality of objects included in the image. In addition, the electronic device 100 may obtain text information for the selected object by inputting information relating to the plurality of objects and information relating to a selected area. In addition, the electronic device 100 may obtain text information with respect to the selected object by inputting tag information of an image in addition to the plurality of objects obtained through the first model 320. The electronic device 100 may edit the text information according to a user input.

The electronic device 100 may compare the obtained text information with pre-stored text information and perform a search, at operation S550. In detail, the electronic device 100 may compare the obtained text information with the pre-stored text information and search for an image having the same or similar text information as the obtained text information. As another example, the electronic device 100 may compare the obtained text information with tag information of an image and search for the image.

The electronic device 100 may provide a search result to a user, at operation S560. In other words, the electronic device 100 may search for an image related to the selected object from among the pre-stored images based on the text information and provide the image to a user.

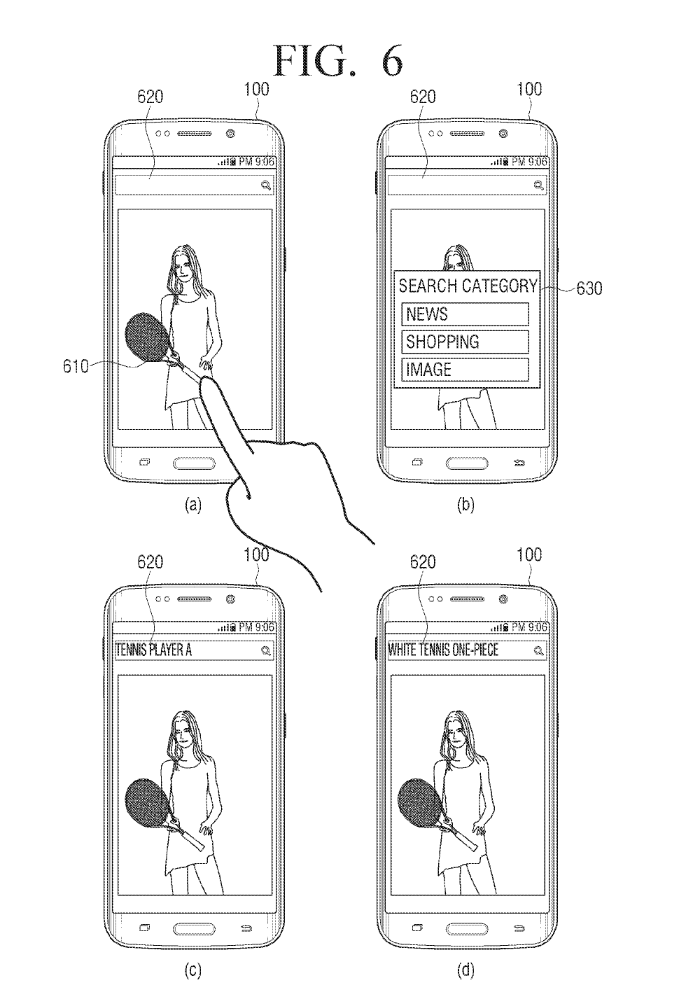

FIG. 6 is a diagram illustrating obtaining text information of an object, according to an example embodiment.

First, an electronic device 100 may display an image including a plurality of objects, as illustrated in section (a) of FIG. 6. The image may include an object of a tennis player wearing a white tennis garment (hereinafter referred to as “player object”) 610.

In addition, the electronic device 100 may receive a user input to select the player object 610, as illustrated in section (a) of FIG. 6. The user input to select the player object 610 may be a long press touch input to press an area in which the player object is displayed for more than a preset time, but is not limited thereto. The player object may be selected through a different user input.

When a user input to select the player object 610 is received, the electronic device 100 may display a first UI 630 to set a search category in one area of a display, as illustrated in section (b) of FIG. 6. The electronic device 100 may display the first UI 630 at a point at which the user input is detected, as illustrated in section (b) of FIG. 6, but this is only an example. The electronic device 100 may display the first UI 630 in a preset area (e.g., an upper area or lower area of a screen) of a display screen.

In a case in which a search category is set through the first UI 630, the electronic device 100 may generate text information based on the set search category. In detail, the electronic device 100 may adjust parameters of the second model 340 according to attributes of the set search category and generate different text information.

In detail, in a case in which a user selects a news category from among the first UI 630, the electronic device 100 may set parameters of the second model 340 to obtain text information including factual information with respect to the player object 610. In addition, the electronic device 100 may obtain text information “Tennis player A” including factual information for the player object 610, and as illustrated in section (c) of FIG. 6, display the obtained text information “Tennis player A” in a search window 620.

Meanwhile, in a case in which a user selects a shopping category from among the first UI 630, the electronic device 100 may set parameters of the second model 340 to obtain shopping information including factual information with respect to the player object 610. The shopping information may be information such as clothes, accessories and props worn by the object. In addition, the electronic device 100 may obtain text information “white tennis dress” including shopping information for the player object 610, and as illustrated in section (d) of FIG. 6, display the obtained text information “white tennis dress” in the search window 620.

The electronic device 100 may edit the text information displayed in the search window 620 according to a user input. For example, the electronic device 100 may edit the “white tennis dress” illustrated in section (d) of FIG. 6 to “white sleeveless tennis dress” according to a user input.

When a user input to select a search icon included in the search window 620 is received, the electronic device 100 may generate a query based on the obtained text information and transmit the generated query to the external search server 200. The electronic device 100 may include information relating to a set search category in the query through the first UI 630 and transmit the query to the external search server 200. The external search server 200 may obtain a search result based on the text information and search category included in the query. The external search server 200 may search for information that corresponds to the text information from among information included in the set search category. For example, in a case in which the set search category is a news category, the external search server 200 may search for news corresponding to the text information within the news category. In a case in which the set search category is a shopping category, the external search server 200 may search for a shopping item corresponding to the text information within the shopping category.

When a search result is received from the external search server 200, the electronic device 100 may provide the received search result.

In the example embodiment described above, it is described that a user sets a search category via the first UI 630, but this is only an example. The electronic device 100 may generate text information for each of all search categories, and obtain a search result for all search categories based on the generated text information.

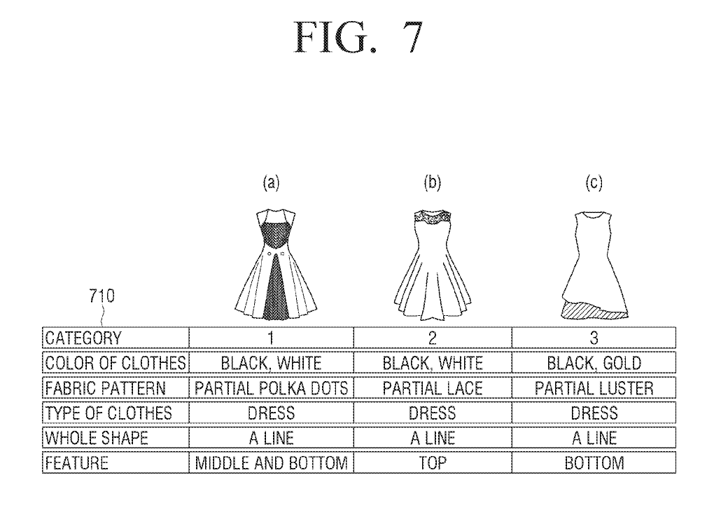

FIG. 7 is a diagram illustrating obtaining text information of an object according to a type of the object, according to an example embodiment.

The electronic device 100 may obtain text information of an object according to a type of object. That is, the electronic device 100 may store a description of an item to be obtained, according to a type of object. That is, the first model 320 and the second model 340 may be, when text information of an object is obtained, trained to obtain information relating to a description or property of an item to be obtained according to a type of object.

For example, in a case in which a type of object is a dress type, the electronic device 100 may obtain description of the object based on a description with respect to a color of clothes, a fabric pattern, a type of clothes, a whole shape, a characteristic of clothes, etc. In a case in which a first dress object as illustrated in section (a) of FIG. 7 is selected, the electronic device 100 may obtain “black, white” as information relating to a color of clothes, “partial polka dot” as information relating to a fabric pattern, “dress” as information relating to a type of clothes, “A-line” as information relating to a whole shape, and “middle and bottom” as information relating to a characteristic of clothes. In addition, the electronic device 100 may input information relating to each of the items to the second model 200 and obtain text information of the first dress object “Black and white A-line dress with partial polka dots and features in the middle and bottom.” In a case in which a second dress object as illustrated in section (b) of FIG. 7 is selected, the electronic device 100 may obtain “black, white” as information relating to a color of clothes, “partial lace” as information relating to a fabric pattern, “dress” as information relating to a type of clothes, “A-line” as information relating to a whole shape, and “top” as information relating to a characteristic of clothes. In addition, the electronic device 100 may input information relating to each of the items to the second model 200 and obtain text information of the second dress object “Black and white A-line dress with partial lace and features at the top.” In a case in which a third dress object as illustrated in section (c) of FIG. 7 is selected, the electronic device 100 may obtain “black, gold” as information relating to a color of clothes, “partial luster” as information relating to a fabric pattern, “dress” as information relating to a type of clothes, “A line” as information relating to a whole shape, and “bottom” as information relating to a characteristic of clothes. In addition, the electronic device 100 may input information relating to each of the items to the second model 200 and obtain text information of the third dress object “Black and gold A-line dress with partial luster and features at the bottom.”

In the example embodiment described above, characteristics for a dress object are described, but this is only an example. A description for every object type may be stored. For example, for a bag object, description categories and values thereof, such as a bag type, a bag texture, a bag size, a bag color, and the like, may be stored. For a shoes object, characteristics and values thereof, such as a shoes type, a shoes pattern, a shoes quality, a shoes color, and the like, may be stored.

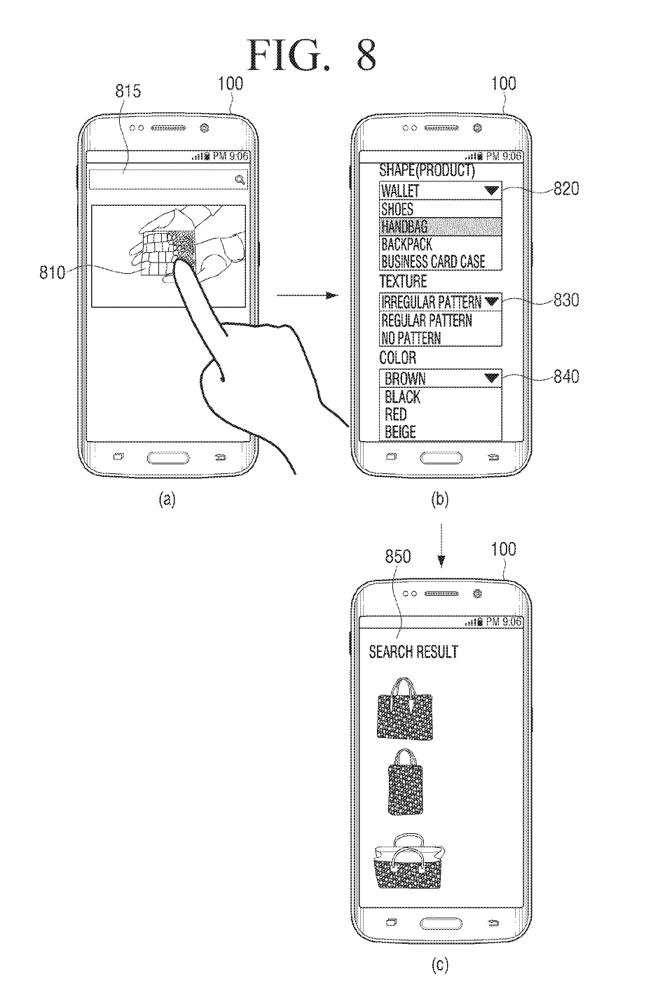

FIG. 8 is a diagram illustrating modifying an item description, according to an example embodiment.

First, the electronic device 100 may, as illustrated in section (a) of FIG. 8, provide an image including a wallet object 810, and receive a user input to select the wallet object 810.

In a case in which a user input to select the wallet object 810 is received, the electronic device 100 may obtain text information for the wallet object 810 by using the first model 320 and the second model 340. The electronic device 100 may obtain the text information for the wallet object 810 based on a description item corresponding to a type of wallet object 810. For example, the electronic device 100 may obtain text information for the wallet object 810 “brown wallet with an irregular pattern.”

In particular, the electronic device 100 may, as illustrated in section (b) of FIG. 8, display a second UI including a plurality of menus 820, 830 and 840 for changing words for a plurality of characteristics of the wallet object 810. For example, the second UI may, as illustrated in section (b) of FIG. 8, include a first menu 820 for changing a type of object, a second menu 830 for changing a texture of object, and a third menu 840 for changing a color of object. The second UI may be displayed according to a user command to select a preset icon (e.g., a setting change icon), and may be displayed in the entire area of a display screen, but this is only an example. The second UI may be displayed together with an image.

When a user input to change a word for at least one of a plurality of item characteristics or categories is received through the second UI, the electronic device 100 may change text information according to the received user input. For example, when a user input to change a type of object to “handbag” is received through the first menu 820, the electronic device 100 may obtain changed text information “brown handbag with an irregular pattern.” The changed text information may be displayed in a search window 815.

When a user input to perform a search is received while the changed text information is displayed in the search window 815, the electronic device 100 may generate a query based on the changed text information and transmit the generated query to the external search server 200.

The external search server 200 may obtain a search result based on the text information “brown handbag with an irregular pattern” included in a query, and transmit the search result to the electronic device 100.

The electronic device 100 may provide a search result 850 received from the external search server 200, as illustrated in section (c) of FIG. 8. The image information, shopping information, etc. may be included in the search result.

In addition, the electronic device 100 may change (or edit) a value of the characteristic of the item through various UIs and generate a new search image.

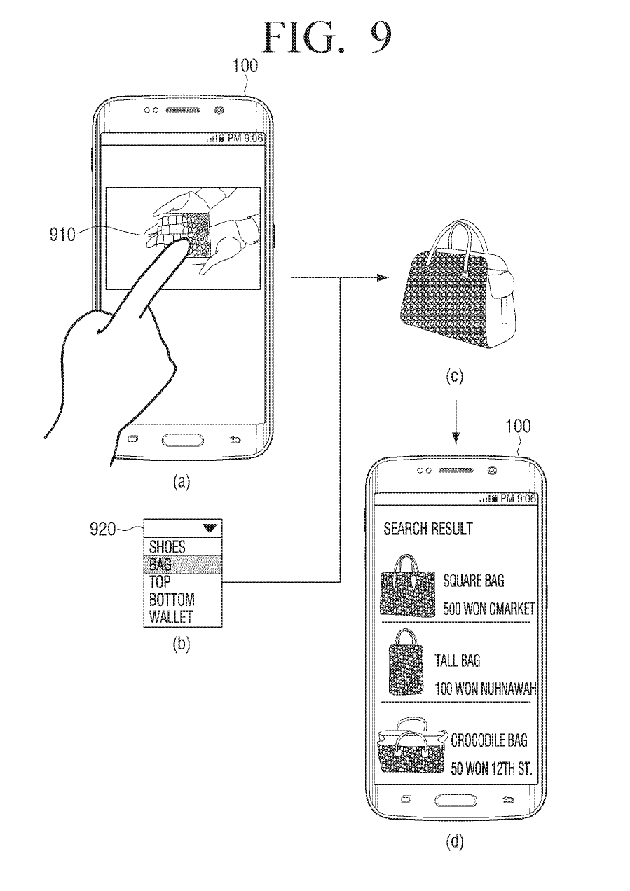

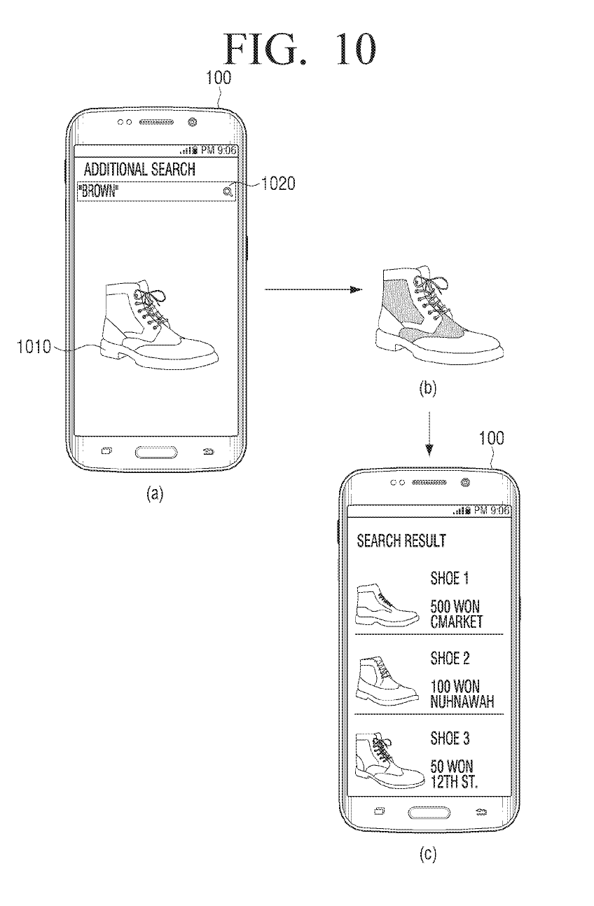

FIGS. 9 and 10 are diagrams illustrating modifying an item description, according to an example embodiment.

In an example embodiment, the electronic device 100 may, as illustrated in section (a) of FIG. 9, provide an image including a wallet object 910, and receive a user input to select the wallet object 910.

In a case in which a user input to select the wallet object 910 is received, the electronic device 100 may obtain text information for the wallet object 910 by using the first model 320 and the second model 340. For example, the electronic device 100 may obtain text information for the wallet object 910 “brown wallet with an irregular pattern.”

In particular, the electronic device 100 may display a menu for changing a word for one of a plurality of description items (categories, characteristics) of the wallet object 910. For example, the electronic device 100 may, as illustrated in section (b) of FIG. 9, display a menu 920 for changing a word for an object type of the item.

The electronic device 100 may edit text object of an object selected by a user according to a user command input through the menu 920. For example, in a case in which the user selects “bag” as a type of object to be changed through the menu 920, the electronic device 100 may edit text information of an object to “brown bag with an irregular pattern.”

The electronic device 100 may generate an image and a new image corresponding to the edited text information by using the third model 345. In this regard, the third model 345 may be a model which to generate a new image by using the image and the edited text information as input data, and may be implemented as a generative adversarial network (GAN). For example, the electronic device 100 may input an image for the wallet object and the edited text information to the third model 345 and obtain a new bag image illustrated in section (c) of FIG. 9.

When a user input to perform a search is received, the electronic device 100 may generate a query including a new bag image and transmit the generated query to the external search server 200. The query may transmit the edited text information together with the new bag image.

The external search server 200 may perform a search based on the received bag image, and transmit a search result to the electronic device 100.

The electronic device 100 may provide the received search result. For example, an electronic device 100 may display the search result on a new screen, as illustrated in section (d) of FIG. 9.

In another example embodiment, the electronic device 100 may, as illustrated in section (a) of FIG. 10, provide an image including a shoe object 1010, and receive a user input to select the shoe object 1010.

In a case in which a user input to select the shoe object 1010 is received, the electronic device 100 may obtain text information for the shoe object 1010 by using the first model 320 and the second model 340. For example, the electronic device 100 may obtain text information for the shoes object 1010 “black leather ankle dress shoe.”

In particular, the electronic device 100 may display a search window 1020 for changing text information. For example, the electronic device 100 may, as illustrated in section (a) of FIG. 10, display a search window 1020 at an upper end of an image including the shoe object 1010.

The electronic device 100 may edit text information of a selected object according to a user command input through the search window 1020. For example, in a case in which the user inputs “brown” through the search window 1020, the electronic device 100 may edit text information of the object to “black leather ankle dress shoe.”

The electronic device 100 may generate an image and a new image corresponding to the edited text information by using the third model 345. For example, the electronic device 100 may input an image for the shoe object 1010 and the edited text information to the third model 345 and obtain a new bag image illustrated in section (b) of FIG. 10.

When a user input to perform a search is received, the electronic device 100 may generate a query including a new shoe image and transmit the generated query to the external search server 200. The query may transmit the edited text information together with the new shoe image.

The external search server 200 may perform a search based on the received shoe image, and transmit a search result to the electronic device 100.

The electronic device 100 may provide the received search result. For example, the electronic device 100 may display the search result on a new screen, as illustrated in section (c) of FIG. 10.

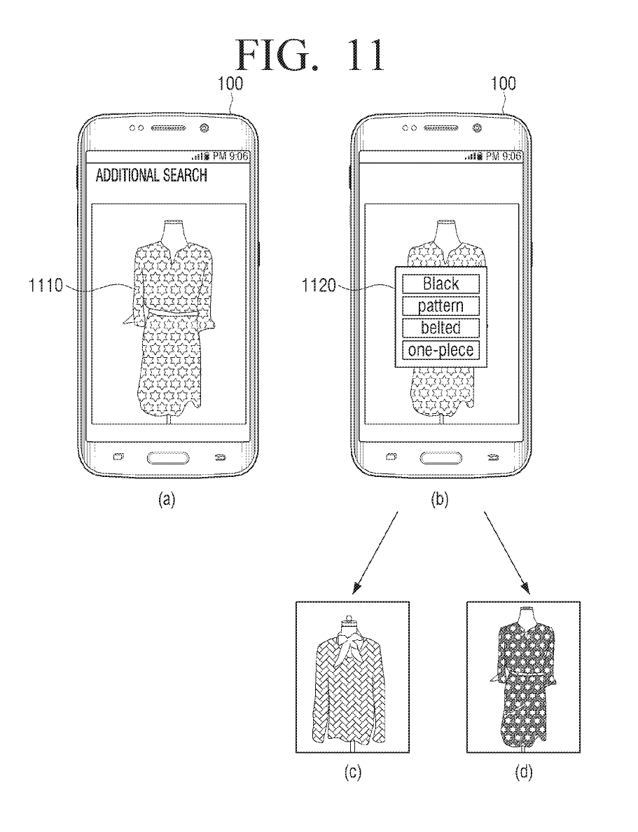

FIG. 11 is a diagram illustrating searching for information relating to an image using a UI, according to an example embodiment.

The electronic device 100 may, as illustrated in section (a) of FIG. 11, provide an image including a dress object 1110, and receive a user input to select the dress object 1110.

In a case in which a user input to select the dress object 1110 is received, the electronic device 100 may obtain text information for the dress object 1110 by using the first model 320 and the second model 340. For example, the electronic device 100 may obtain text information for the dress object 1110 “belted black dress with a pattern.”

The electronic device 100 may display a UI for setting a priority of description items included in the text information. For example, the electronic device 100 may, as illustrated in section (b) of FIG. 11, display a menu 1120 including words for the description items included in the text information. The menu may include the items “Black,” “Pattern,” “Belted” and “one-piece” as values of the description items (categories, characteristics).

When a user command to select at least one of a plurality of items is received, the electronic device 100 may generate weight value information for a selected item. For example, in a case in which “black” and “pattern” are selected, the electronic device 100 may generate first weight value information to set a weight value to the words “black” and “pattern.” As another example, in a case in which “pattern,” “belted” and “one-piece” are selected, the electronic device 100 may generate second weight value information to set a weight value to the words “pattern,” “belted” and “one-piece.”

When a user input to perform a search is received, the electronic device 100 may generate a query including the generated text information and the generated weight value information, and transmit the generated query to the external search server 200. The external search server 200 may search for an image based on the generated text information and the generated weight value information. For example, in a case in which the generated text information and the first weight value information are received, the external search server 200 may, as illustrated in section (c) of FIG. 11, search for “black clothes with a pattern.” In a case in which the generated text information and the generated second weight value information are received, the external search server 200 may search for “a belted one-piece with a pattern,” as illustrated in section (d) of FIG. 11. That is, the external search server 200 may search for an image having a word included in the weight information from among the text information.

The electronic device 100 may receive a search result from the external search server 200, and provide the received search result.

In the example embodiment described above, an image having a word included in weight information is searched, but this is only an example. It is possible to obtain a plurality of images corresponding to text information and align the plurality of images based on the weight information.

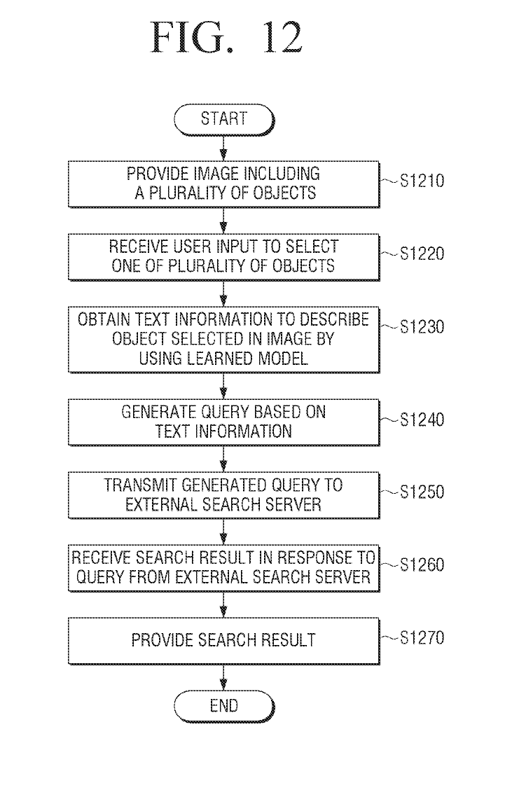

FIG. 12 is a flowchart illustrating a method for controlling an electronic device, according to an example embodiment.

First, the electronic device 100 may provide an image including a plurality of objects, at operation S1210.

The electronic device 100 may receive a user input to select one of a plurality of objects, at operation S1220. The user input may be implemented as one of various inputs, such as a long press touch input, a multi touch input, a force touch input, a drawing touch input, and the like.

The electronic device 100 may obtain text information to describe an object selected in an image by means of a trained model, at operation S1230. In detail, the electronic device 100 may obtain information relating to a plurality of objects included in an image by using a first model trained to receive input of an image and estimate information relating to an object included in the image, and obtain text information to describe a selected object from among the plurality of objects by using a second model trained to receive input of information relating to a plurality of objects and obtain text information relating to the plurality of objects. The first model may be a convolutional neural network (CNN) model. The second model may be a recurrent neural network (RNN) model. In addition, the electronic device 100 may input information relating to a plurality of objects, information relating to a selected area, and tag information of an image together to the second model, and obtain text information for describing a selected object.

The electronic device 100 may generate a query based on the text information, at operation S1240. The electronic device 100 may edit text information according to a user input, and generate a query in which the edited text information is included.

The electronic device 100 may transmit the generated query to the external search server 200, at operation S1250, and receive a search result in response to the query from the external search server 200, at operation S1260.

The electronic device 100 may provide a search result received from the external search server 200, at operation S1270.

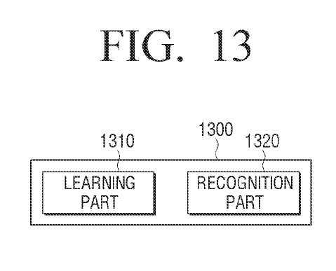

FIG. 13 is a block diagram of an electronic device, according to an example embodiment.

Referring to FIG. 13, the processor 1300 may include at least one of a learning part 1310 and a recognition part 1320. The processor 1300 of FIG. 13 may correspond to a processor 150 of the electronic device 100 and a processor of a data learning server of FIGS. 2A and 2B.

The learning part 1310 may generate or train a first model for recognizing a plurality of objects included in an image and a second model for obtaining text information of an object by means of a learning data. The learning part 1310 may generate a trained model having recognition criteria by using a collected learning data.

For example, the learning part 1310 may generate, train or update a first model for obtaining information relating to a plurality of objects included in an image by using the image as an input data. In addition, the learning part 1310 may generate, train or update a second model for obtaining text information for an object by using at least one of information relating to a plurality of objects, information relating to a selected area and tag information of an image as input data. The learning part 1310 may train the second model to obtain text information relating to an object based on a description item determined according to a type of object. In addition, the learning part 1310 may generate, train or update a third model for obtaining a new image by using an image and edited text information as input data. According to another example embodiment, the first model and the second model may be implemented as an integrated model. That is, the integrated model may use an image as input data and obtain text information relating to an object included in the image.

The recognition part 1310 may use a predetermined data as input data of a trained model and obtain various information.

For example, the recognition part 1320 may use an image as input data of a trained first model and recognize (or estimate or infer) a plurality of objects included in the image. In addition, the recognition part 1320 may use information relating to a plurality of objects, information relating to a selected area and tag information of an image as input data of a trained second model and recognize (or estimate, infer or obtain) text information for an object included in an area selected by a user from among the plurality of objects. In addition, the recognition part 1320 may use an image and edited text information as input data and generate a new image corresponding to the edited text information.

At least a portion of the learning part 1310 and at least a portion of the recognition part 1320 may be implemented as software or manufactured in the form of at least one hardware chip that implements the functions thereof, and mounted in an electronic device. For example, at least one of the learning part 1310 and the recognition part 1320 may be manufactured in the form of an exclusive hardware chip for artificial intelligence (AI), or may be manufactured as a portion of the previous general processor (e.g., CPU or application processor) or a graphic exclusive processor (e.g., GPU), and mounted in the various electronic devices described above. In this regard, the exclusive hardware chip for artificial intelligence may be an exclusive processor which is specialized in probability operation, and may show a higher performance compared with the previous general processor so as to facilitate processing of a computing operation in the field of artificial intelligence such as machine learning. When the learning part 1310 and the recognition part 1320 are implemented as a software module (or a program module including an instruction), the software module may be stored in non-transitory computer readable media. In this regard, a software module may be executed by an operating system (OS) as a predetermined application. Alternatively, part of the software module may be provided by an operating system (OS), and some of the at least one software module may be provided by a predetermined application.

In this case, the learning part 1310 and the recognition part 1320 may be mounted on one electronic device or mounted on separate electronic devices, respectively. For example, one of the learning part 1310 and the recognition part 1320 may be installed in the electronic device 100, and the other may be installed in an external server. The learning part 1310 and the recognition part 1320 may provide the model information constructed by the learning part 1310 to the recognition part 1320 via wire or wirelessly, or the data input to the learning part 1320 may be provided to the learning part 1310 as additional learning data.

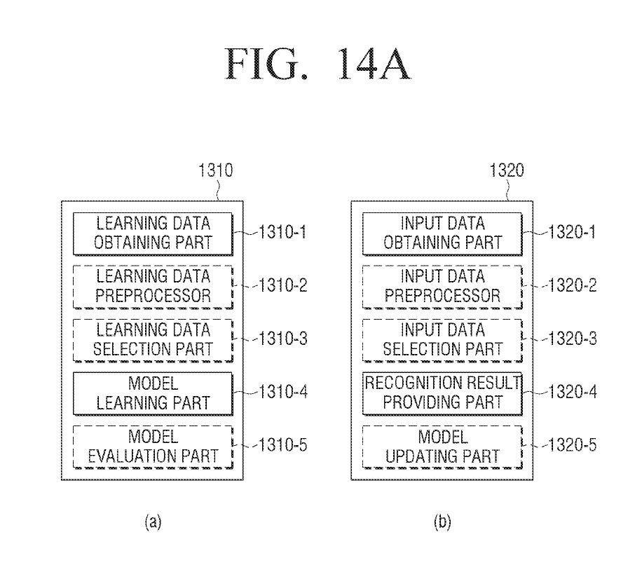

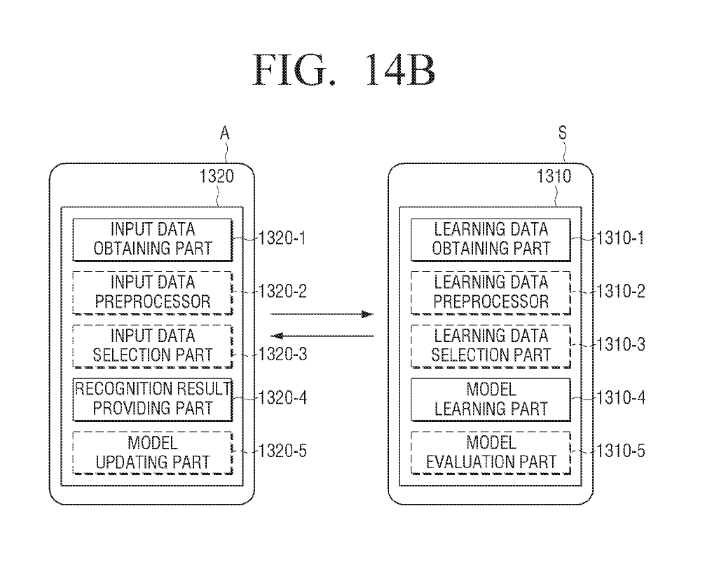

FIGS. 14A and 14B are block diagrams of an electronic device, according to an example embodiment.

Referring to section (a) of FIG. 14A, the learning part 1310 may include a learning data obtaining part 1310-1 and a model learning part 1310-4. In addition, the learning part 1310 may further selectively include at least one of a learning data preprocessor 1310-2, a learning data selection part 1310-3, and a model evaluation part 1310-5.

The learning data obtaining part 1310-1 may obtain learning data required for the first to third models. In an example embodiment, the learning data obtaining part 1310-1 may obtain an image, information relating to a plurality of objects and text information as learning data. The learning data may be data collected or tested by the learning part 1310 or the manufacturer of the learning part 1310.

The model learning part 1310-4 may train, by using learning data, a model to recognize an object included in an image, to obtain text information for an object, and to generate a new image based on edited text information. For example, the model learning part 1310-4 may train an artificial intelligence model through supervised learning using at least a portion of the learning data as a criterion for identification. In addition, the model learning portion 1310-4 may train itself using a learning data without additional instructions and train an artificial intelligence model through unsupervised learning that discovers an identification criterion for identifying a situation. Further, the model learning unit 1310-4 may train the artificial intelligence model through reinforcement learning using, for example, feedback as to whether a result of the situation judgment based on learning is correct. Also, the model training unit 1310-4 may teach an artificial intelligence model by using, for example, a learning algorithm including an error back-propagation method or a gradient descent method.

If there are a plurality of pre-constructed artificial intelligence models, the model learning part 1310-4 may identify an artificial intelligence model with high relevancy between input learning data and basic learning data as an artificial intelligence model to learn. In this case, the basic learning data may be pre-classified according to the type of data, and the artificial intelligence model may be pre-established according to the type of data. For example, the basic learning data may be pre-classified by various criteria such as an area where the learning data is generated, a time at which the learning data is generated, a size of the learning data, a genre of the learning data, a creator of the learning data, a type of object in the learning data, etc.

When an artificial intelligence model is trained, the model learning part 1310-4 may store the trained artificial intelligence model. In this regard, the model learning part 1310-4 may store the trained artificial intelligence model in the memory 130 of the electronic device 100. Alternatively, the model learning part 1310-4 may store the trained artificial intelligence model in a memory of a server (e.g., a personal secretary chatting server 1100) connected to the electronic device 100 via a wired or wireless network.

The data learning part 1310 may further include a learning data pre-processor 1310-2 and a learning data selection part 1310-3 to improve a recognition result of the artificial intelligence model or save resources or time required for generating an artificial intelligence model.

The learning data preprocessor 1310-2 may pre-process obtained data so that the obtained data may be used in learning for object recognition and text information generation. The learning data preprocessor 1310-2 may process the obtained data in a predetermined format so that the model learning part 1310-4 may use the obtained data for learning for object recognition and text information generation. For example, the learning data preprocessor 1310-2 may remove text (e.g., proverb, exclamation, and the like) that is unnecessary for an artificial intelligence model from among the input text information.

The learning data selection part 1310-3 may select data required for learning from among the data obtained from the learning data obtaining part 1310-1 or data preprocessed in the learning data preprocessor 1310-2. The selected learning data may be provided to the model learning part 1310-4. The learning data selection part 1310-3 may select learning data required for learning from among the obtained or preprocessed data according to a preset selection criterion. The learning data selection part 1310-3 may also select learning data according to a preset selection criterion by learning by the model learning part 1310-4.

The learning part 1310 may further include a model evaluation unit 1310-5 to improve a recognition result of the artificial intelligence model.

The model evaluation part 1310-5 may input evaluation data to the artificial intelligence model, and when a recognition result output from the evaluation data does not satisfy a predetermined criterion, control the model learning part 1010-4 to learn again. In this case, the evaluation data may be predefined data for evaluating the artificial intelligence model.

For example, in a case in which the number or the ratio of the evaluation data whose recognition result is inaccurate from among the recognition results of the trained artificial intelligence model for the evaluation data exceeds a preset threshold, the model evaluation part 131-5 may evaluate that a predetermined criterion is not satisfied.

On the other hand, in a case in which a plurality of trained artificial intelligence models are present, the model evaluation part 1310-5 may evaluate whether each of the trained artificial intelligence models satisfies a predetermined criterion, and determine a model satisfying the predetermined criterion as a final artificial intelligence model. In this case, in a case in which a plurality of models satisfying a predetermined criterion are present, the model evaluation part 1310-5 may determine any one model or a preset number of models previously set in descending order of an evaluation score as a final artificial intelligence model.

Referring to section (b) of FIG. 14A, the recognition part 1320 according to some example embodiments may include an input data obtaining part 1320-1 and a recognition result providing part 1320-4.

In addition, the recognition part 1320 may further selectively include at least one of an input data preprocessor 1320-2, an input data selection part 1320-3, and a model updating part 1320-5.

The input data obtaining part 1320-1 may recognize an object included in an image, and data required to obtain text information for the object. The recognition result providing part 1320-4 may apply the input data obtained in the input data obtaining part 1320-1 to a trained artificial intelligence model as an input value and recognize an object included in an image, and obtain text information for the object. The recognition result providing part 1320-4 may apply data selected by the input data preprocessor 1320-2 and the input data selection part 1320-3 to an artificial intelligence model as an input value and obtain a recognition part. A recognition result may be determined by the artificial intelligence model.

In an example embodiment, the recognition result providing part 1320-4 may apply image data obtained in the input data obtaining part 1320-1 to a trained first model and recognize (or estimate) an object included in an image.

In another example embodiment, the recognition result providing part 1320-4 may apply information relating to an object obtained in the input data obtaining part 1320-1, information relating to a selected area and tag information of an image to a trained second model, and obtain (or estimate) text information of an object included in the selected area.

In another example embodiment, the recognition result providing part 1320-4 may apply an image obtained in the input data obtaining part 1320-1 and edited text information to a trained third model, and obtain (or estimate) a new image corresponding to the edited text information.

The data recognition part 1320 may further include an input data preprocessor 1320-2 and an input data selection part 1020-3 to improve a recognition result of an artificial intelligence model or save resources or time to provide a recognition result.

The input data preprocessor 1320-2 may pre-process the obtained data so that the data obtained to be input to the first to third models may be used. The input data preprocessor 1320-2 may process the obtained data in a predefined format so that the recognition result providing part 1320-4 may use data obtained for recognizing an object and obtaining text information.

The input data selection part 1320-3 may select data required for situation determination from among the data acquired in the input data obtaining part 1320-1 or the data preprocessed in the input data preprocessor 1320-2. The selected data may be provided to the recognition result providing part 1320-4. The input data selection part 1320-3 may select some or all of the obtained or preprocessed data according to a preset selection criterion for the situation determination. The input data selection part 1320-3 may also select data according to a preset selection criterion through learning by the model learning part 1310-4.

The model updating part 1320-5 may control an artificial intelligence model to be updated, based on an evaluation of a recognition result provided by the recognition result providing part 1320-4. For example, the model updating part 1320-5 may provide a recognition result provided by the recognition result providing part 1320-4 to the model learning part 1310-4, to thereby request the model learning part 1310-4 to further train or update an artificial intelligence model.

In FIG. 14B, an electronic device A and an external server S are interlocked with each other to learn and determine data.

Referring to FIG. 14B, the external server S may recognize an object included in an image, and learn a criterion for obtaining text information of the object. The electronic device A may recognize an object included in an image by using models generated based on a learning result by the server S, and obtain text information of the object.

The model learning part 1310-4 of the server S may carry out a function of the learning part illustrated in FIG. 13. The model learning part 1310-4 of the server S may learn a determination criterion (or a recognition criterion) for the first to third models.

In addition, the recognition result providing part 1320-4 of the electronic device 100 may recognize an object included in an image by applying data selected by the input data selection part 1320-3 to an artificial intelligence model generated by the server S, and obtain text information of the object. Alternatively, the recognition result providing part 1320-4 of the electronic device 100 may receive an artificial intelligence model generated by a server from the server, recognize an object included in an image by using the received artificial intelligence model, and obtain text information of the object.

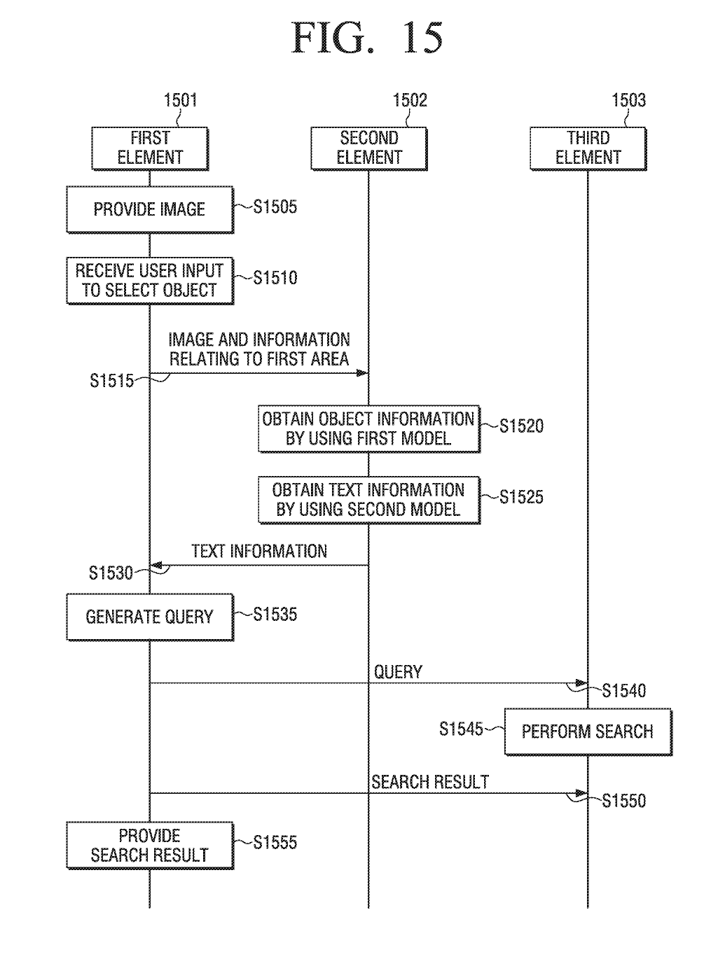

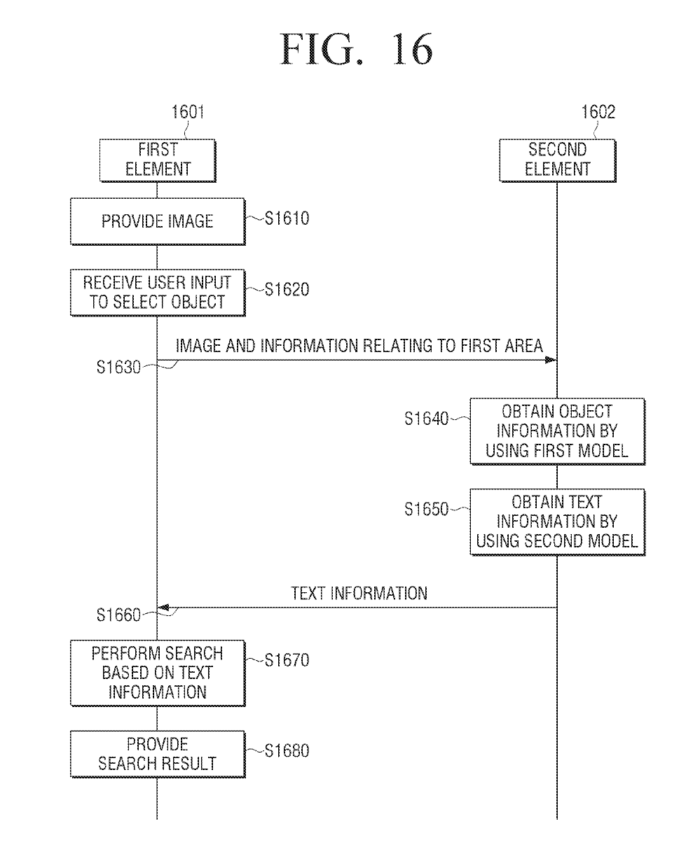

FIGS. 15 and 16 are flowcharts illustrating a trained model, according to an example embodiment.

In FIGS. 15 and 16, a network system using a trained artificial intelligence model may include a first element 1501 and 1601, a second element 1502 and 1602, and a third element 1503.

The first element 1501 and 1601 may be an electronic device A, and the second element 1502 and 1602 may be a server S in which an artificial intelligence model is stored. Alternatively, the first element 1501 and 1601 may be a general processor, and the second element 1502 and 1602 may be a processor exclusive for artificial intelligence. Alternatively, the first element 1501 and 1601 may be at least one application, and the second element 1502 and 1602 may be an operating system (OS). That is, the second element 1502 and 1602 may be an element that is more integrated, dedicated, has less delay, has a better performance, or has more resources than the first element 1501 and 1601, and which is capable of processing a large number of operations required to generate, update or apply a data recognition model more quickly and effectively than the first element 1501 and 1601.

An interface for transmitting and receiving data between the first element 1501 and 1601 and a second element 1502 and 1602 may be defined.

For example, the interface may be an application program interface (API) having a learning data to be applied to a recognition model as a factor value (or an intermediation value or a transfer value). The API may be defined as a sub routine or a set of function in which any one protocol (e.g., a protocol defined in the electronic device A) may call for a certain processing of another protocol (e.g., a protocol defined in the server S). That is, an environment in which an operation of another protocol may be performed in any one protocol may be provided through the API.

The third element 1503 may obtain a search result associated with an object based on data received from at least one of the first element 1501 and 1601 and the second element 1502 and 1602. The third element 1503 may correspond to, for example, an external search server 200. The data received by the third element 1503 may be, for example, an image, edited text information, etc. According to an example embodiment, the third element 1503 may be, together with the second element 1502, implemented as one device.

In FIG. 15, the first element 1501 may provide an image, at operation S1505. The image may include a plurality of objects. In addition, the first element 1501 may receive a user input to select an object, at operation S1510.

The first element 1501 may transmit information relating to an image and a first area to the second element 1502, at operation S1515. The information relating to the first area may be information relating to a touch coordinate at which the user input is received. In addition, the first element 1501 may transmit tag information relating to the image together with the image.

The second element 1502 may obtain information relating to the object by using a first model, at operation S1520. In detail, the second element 1502 may input an image to the first model and obtain information relating to a plurality of objects included in the image.

The second element 1502 may obtain text information for a selected object by using a second model, at operation S1525. In detail, the second element 1502 may input information relating to a plurality of objects and information relating to a selected area to the second model and obtain text information for an object included in an area selected by a user from among the plurality of objects. In addition, the second element 1502 may input tag information of an image together with information relating to the plurality of objects and information relating to the selected area to the second model and obtain text information for the object included in the selected area.

The second element 1502 may transmit the obtained text information to the first element 1501, at operation S1530. In the example embodiment described above, the second element 1502 may transmit text information to the first element, but this is only an example. The second element 1502 may directly transmit text information to the third element.

The first element 1501 may generate a query based on the received text information, at operation S1535. The query may receive the received text information. However, according to another example embodiment, the query may include text information edited by a user or a new image generated through the third model.

The first element 1501 may transmit the generated query to an external third element, at operation S1540, and the third element 1503 may perform a search based on the query, at operation S1545.

The third element 1503 may transmit a search result to the third element 1501, at operation S1550. The first element 1501 may provide the received search result to a user, at operation S1555.

In FIG. 16, the first element 1601 may provide an image, at operation S1610. The image may include a plurality of objects. In addition, the first element 1601 may receive a user input to select an object, at operation S1620.

The first element 1601 may transmit information relating to an image and a first area to the second element 1602, at operation S1630. The information relating to the first area may be information relating to a touch coordinate at which the user input is received. In addition, the first element 1601 may transmit tag information relating to the image together with the image.

The second element 1602 may obtain information relating to the object by using a first model, at operation S1640. In detail, the second element 1502 may input an image to the first model and obtain information relating to a plurality of objects included in the image.

The second element 1602 may obtain text information for a selected object by using a second model, at operation S1650. In detail, the second element 1602 may input information relating to a plurality of objects and information relating to a selected area to the second model and obtain text information for an object included in a selected area from among the plurality of objects. In addition, the second element 1602 may input tag information of an image together with information relating to the plurality of objects and information relating to the selected area to the second model and obtain text information for the object included in the selected area.

The second element 1602 may transmit the obtained text information to the first element 1601, at operation S1660.

The electronic device 1601 may perform a search based on the received text information, at operation S1670. In detail, the first element 1601 may compare the received text information with the pre-stored text information and search for an image having an identical or similar text information as the received text information.

The first element 1601 may provide a search result to a user, at operation S1680.

According to the various example embodiments described above, the user can obtain a detailed search result with respect to an object selected by the user from among objects included in an image more quickly and conveniently.

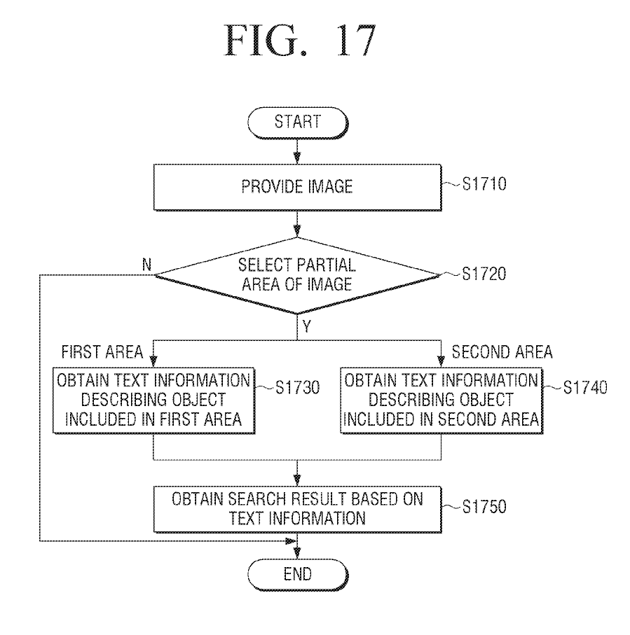

FIG. 17 is a flowchart illustrating a method for controlling an electronic device for providing a search result, according to an example embodiment.

First, the electronic device 100 may provide an image, at operation S1710. The image may include a plurality of objects.

The electronic device 100 may determine whether a partial area of the image is selected according to a user input, at operation S1720.

In a case in which the first area is selected, the electronic device 100 may obtain text information describing an object included in a first area, at operation S1730. In detail, the electronic device 100 may input an image and information relating to a selected first area to a trained model (e.g., the first model 320 and the second model 340) and obtain text information describing an object included in the first area.

In a case in which a second area is selected, the electronic device 100 may obtain text information describing an object included in the second area, at operation S1740. In detail, the electronic device 100 may input an image and information relating to a selected second area to a trained model (e.g., the first model 320 and the second model 340) and obtain text information describing an object included in the second area.

The electronic device 100 may obtain a search result based on the text information describing an object included in the first area and the text information describing an object included in the second area, at operation S1750. In detail, the electronic device 100 may generate a query based on the input text information and transmit the generated query to an external search server, and receive a search result in response to the text information from the external search server.

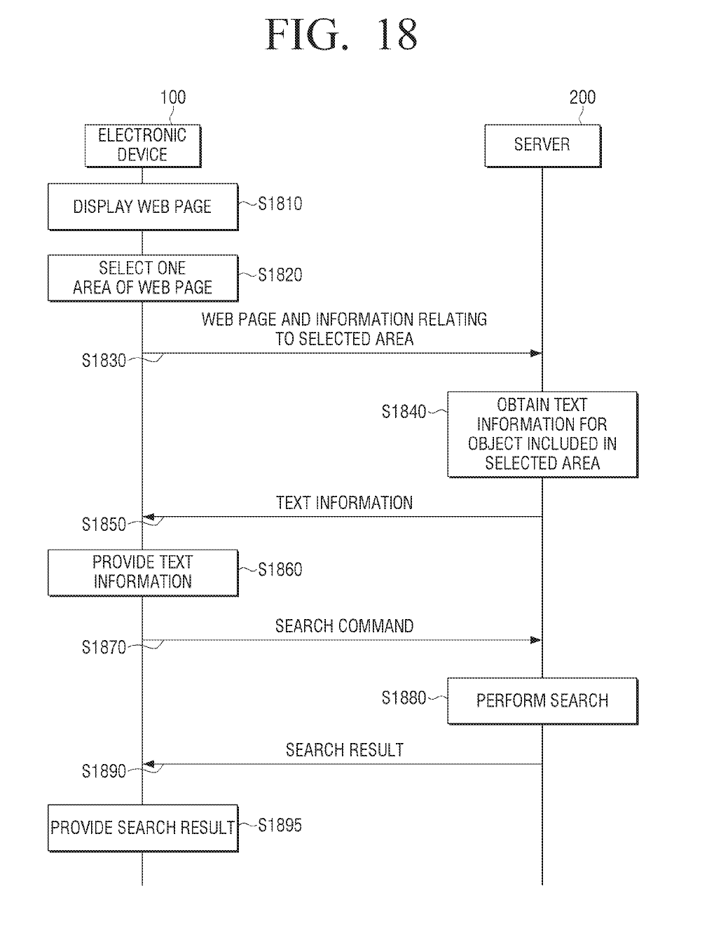

FIG. 18 is a flowchart illustrating providing a search result, according to an example embodiment.

The server 200 may be implemented as one server, but this is only an example. The server 200 may include a server performing a search with a server obtaining text information.

First, the electronic device 100 may display a web page, at operation S1810. The web page may include a plurality of images or objects.

The electronic device 100 may receive a user command to select one area of the web page.

The electronic device 100 may transmit information relating to the web page and the selected area to the server 200, at operation S1830. The electronic device 100 may transmit a captured image of the web page and coordinate information of the selected area, but this is only an example. The electronic device 100 may transmit an address of the web page and coordinate information of the selected area to the server 200.

The server 200 may obtain text information for an object included in the selected area, at operation S1840. In detail, the server 200 may input the image of the captured image and the information relating to the selected area to a trained model (e.g., the first model 320 and the second model 340) and obtain text information for an object included in the selected area.

The server 200 may transmit text information to the electronic device 100, at operation S1850.

The electronic device 100 may provide the text information, at operation S1860, and transmit a search command for the text information to the server 200 according to a user command, at operation S1870. The electronic device 100 may transmit a search command for text information edited by a user to the server 200, as described above.

The server 200 may perform a search based on the text information, at operation S1880, and transmit a search result to the electronic device 100, at operation S1890.

The electronic device 100 may provide the received search result, at operation S1895.

The above-described example embodiments may be implemented as a software program including an instruction stored on machine (e.g., computer)-readable storage media. The machine is a device capable of calling a stored instruction from the storage medium and operating according to the called instruction, and may include an electronic device (e.g., an electronic device 100) according to the above-described example embodiments. When the command is executed by a processor, the processor may perform a function corresponding to the command directly or using other components under the control of the processor. The command may include a code generated or executed by a compiler or an interpreter. A machine-readable storage medium may be provided in the form of a non-transitory storage medium. Herein, the term “non-transitory” only denotes that a storage medium does not include a signal but is tangible, and does not distinguish the case where a data is semi-permanently stored in a storage medium from the case where a data is temporarily stored in a storage medium.

According to an example embodiment, the method according to the above-described various example embodiments may be provided as being included in a computer program product. The computer program product may be traded as a product between a seller and a consumer. The computer program product may be distributed online in the form of machine-readable storage media (e.g., compact disc read only memory (CD-ROM)) or through an application store (e.g., Play Store™). In the case of online distribution, at least a portion of the computer program product may be at least temporarily stored or temporarily generated in a server of the manufacturer, a server of the application store, or a storage medium such as memory.

Each of the components (e.g., module or program) according to the various example embodiments may include a single entity or a plurality of entities, and some of the corresponding sub components described above may be omitted, or another sub component may be further added to the various example embodiments. Alternatively or additionally, some components (e.g., module or program) may be combined to form a single entity which performs the same or similar functions as the corresponding elements before being combined. Operations performed by a module, a program, or other component, according to various exemplary embodiments, may be sequential, parallel, or both, executed iteratively or heuristically, or at least some operations may be performed in a different order, omitted, or other operations may be added.

What is claimed is:

1. An electronic device, comprising:
a display;
a communication interface;
a processor configured to control the display and the communication interface; and
a memory configured to store at least one program executed by the processor,
wherein when executing the at least one program the processor is configured to:
control the display to display an image;
receive a user input indicating an area of the display;
if the area of the display indicates a first area of the display at which a first object in the image is displayed, obtain a first search result by using first text information describing a state of the first object by using a trained model; and
if the area of the display indicates is a second area of the display at which a second object in the image is displayed, obtain a second search result by using second text information describing a state of the second object by using the trained model.

2. The electronic device as claimed in claim 1, wherein the first text information and the second text information are obtained using a first model trained to receive input of an image and to obtain information relating to a plurality of objects included in the image and a second model trained to receive input of information relating to a plurality of objects obtained by the first model and information relating to an area selected by a user and to obtain text information describing an object included in an area selected by a user.

3. The electronic device as claimed in claim 2, wherein the first model is a convolutional neural network (CNN) and the second model is a recurrent neural network (RNN).

4. The electronic device as claimed in claim 2, wherein the processor is configured to obtain tag information of the image, and
wherein the first text and the second text are obtained by inputting information relating to the plurality of objects, information relating to an area selected by the user and the tag information to the second model.

5. The electronic device as claimed in claim 1, wherein the first text information and the second text information comprise at least one of information relating to a relationship between an object included in the area and another object, detailed description information for an object included in the area, and behavior information for an object included in the area.

6. The electronic device as claimed in claim 1, wherein the processor is configured to set a search category according to a user input, and
wherein the first text information and the second text information are obtained based on the set search category.

7. The electronic device as claimed in claim 1, wherein the processor is configured to identify a type of an object included in the area, and
wherein the first text information is obtained based on a description item corresponding to the identified type of the object.

8. The electronic device as claimed in claim 7, wherein the first text information comprises a plurality of words corresponding to a plurality of description items, and
wherein the processor is configured to:
control the display to provide a user interface (UI) for changing a word included in at least one of the plurality of description items included in the first text information;
based on receiving a user input for changing a word for at least one of the plurality of items through the UI, change the first text information according to the user input; and
control the communication interface to transmit the changed first text information to an external search server.

9. The electronic device as claimed in claim 8, wherein the processor is configured to generate a new image corresponding to the changed first text information by using a third model trained to receive input of an image and text information and generate a different image, and to control the communication interface to transmit the new image to the external search server.

10. The electronic device as claimed in claim 7, wherein the processor is configured to control the display to provide a user interface (UI) for setting a priority for at least one of the plurality of description items, and based on a weight value for at least one description item being set through the UI, to generate a word for at least one description item for which the weight value is set.

11. A computer-readable recording medium for storing a program that implements a method of an electronic device providing a search result, wherein the method comprises:
displaying an image on the electronic device;
receiving a user input that indicates area displayed on the electronic device;
if the area of the display indicates is a first area of the display at which a first object in the image is displayed, obtaining a first search result by using first text information describing a state of the first object using a trained model; and
if the area of the display indicates is a second area of the display at which a second object in the image is displayed, obtaining a second search result using second text information describing a state of the second object by using the trained model.

12. The computer-readable recording medium as claimed in claim 11, wherein the first text information and the second text information are obtained using a first model trained to receive input of an image and to obtain information relating to a plurality of objects included in the image and a second model trained to receive input of information relating to a plurality of objects obtained by the first model and information relating to an area selected by a user and to obtain text information describing an object included in an area selected by a user.

13. The computer-readable recording medium as claimed in claim 12, wherein the first model is a convolutional neural network (CNN) and the second model is a recurrent neural network (RNN).

14. The computer-readable recording medium as claimed in claim 12, wherein the method further comprises obtaining tag information of the image,
wherein the first text and the second text are obtained by inputting information relating to the plurality of objects, information relating to an area selected by the user and the tag information to the second model.

15. The computer-readable recording medium as claimed in claim 11, wherein the first text information and the second text information comprise at least one of information relating to a relationship between an object included in the area and another object, detailed description information for an object included in the area, and behavior information for an object included in the selected area.

16. The computer-readable recording medium as claimed in claim 11, wherein the method further comprises set a search category according to a user input, wherein the first text information and the second text information are obtained based on the set search category.

17. The computer-readable recording medium as claimed in claim 11, wherein the method further comprises identifying a type of an object included in the area,
wherein the first text information is obtained based on a description item corresponding to the identified type of the object.

18. The computer-readable recording medium as claimed in claim 17, wherein the first text information comprises a plurality of words corresponding to a plurality of description items, and
wherein the method further comprises:
providing a user interface (UI) for changing a word included in at least one of the plurality of description items included in the first text information;
based on receiving a user input for changing a word for at least one of the plurality of items through the UI, changing the first text information according to the user input; and
transmitting the changed first text information to an external search server.

19. The computer-readable recording medium as claimed in claim 18, wherein the method comprises:
generating a new image corresponding to the changed first text information by using a third model trained to receive input of an image and text information and generate a different image; and
transmitting the new image to the external search server.

20. The computer-readable recording medium as claimed in claim 17, wherein the method comprises:
providing a user interface (UI) for setting a priority for at least one of the plurality of description items; and
based on a weight value for at least one description item being set through the UI, generating a word for at least one description item for which the weight value is set.
